(19) United States
(12) Patent Application Publication
(10) Pub. No.: US 2015/0181477 A1
(43) Pub. Date: Jun. 25, 2015

(54) METHOD AND SYSTEM FOR AUTOMATICALLY UPDATING A NEIGHBOR LIST

(71) Applicant: Wipro Limited, Bangalore (IN)

(72) Inventors: Saptarshi Chaudhuri, Bangalore (IN); Irfan Baig, Bangalore (IN)

(73) Assignee: Wipro Limited, Bangalore (IN)

(21) Appl. No.: 14/182,042

(22) Filed: Feb. 17, 2014

(30) Foreign Application Priority Data
Dec. 24, 2013 (IN) 6076/CHE/2013

(51) Int. Cl. H04W 36/00

(52) U.S. Cl. CPC H04W 36/0061

(57) ABSTRACT

A method and system for automatically updating a neighbor list associated with a serving base station is disclosed. The method involves receiving a measurement report from a User Equipment (UE) associated with the serving base station, wherein the measurement report comprises at least one relative signal strength measurement between the UE and each of a plurality of neighboring base stations; comparing the at least one relative signal strength measurement between the UE and the plurality of neighboring base stations with a current signal strength between the UE and the serving base station; identifying at least one of the plurality of neighboring base stations having a greater relative signal strength with respect to the UE than the serving base station a predefined number of times based on the comparison; and updating the neighbor list associated with the serving base station with the identified at least one neighboring base stations.

This application claims the benefit of Indian Patent Application filing Number 6076/CHE/2013, filed on Dec. 24, 2013, which is hereby incorporated by reference in its entirety.

### FIELD

This disclosure relates generally to managing neighbor lists in a wireless communication environment, and more particularly to a method and system for automatically updating a neighbor list.

### BACKGROUND

Long Term Evolution (LTE) or 4G network is a wireless communication network designed to provide subscribers with a high speed internet experience on their mobile devices without any traffic restrictions either in the mobile device or in the network. One of the requirements of LTE is to provide unbroken connections between base stations, also called Evolved Node Bs or eNodeBs or eNBs, and User Equipment (UEs) moving at high speeds. This feature of providing unbroken connections may be accomplished by a serving base station by performing a handover or handoff to another base station. The serving base station or serving eNB decides when to initiate the handover and to which eNB the UE needs to be handed over. These handovers may be based on the UE signal strength measurements of the Neighbour eNBs.

The serving eNB knows its neighbours through a Neighbour Relation Table (NRT). An eNB uses the NRT to determine which neighbour to handover a UE to. Typically, a eNB neighbour is added and maintained manually by the network operator. The neighbour list generation and maintenance may turn out to be a significant overhead in the existing mobile networks especially when the networks are expanded and new eNBs are added. For LTE, the task of manually maintaining a neighbour list is further challenging for operators because in addition to defining intra LTE neighbour relations, the operator also has to provision 2G and 3G neighbours. To overcome this overhead, the 3GPP standard covering LTE specifies an Automatic Neighbour Relation (ANR) function wherein UEs connected to a serving eNB may provide information regarding neighbouring eNBs to the serving eNB. The serving eNB may then update its NRT based on this information. However, in this case, the number of neighbours reported by the UEs may be substantially high and processing the high number of neighbours to decide the target neighbour for handover may be time consuming and computationally intensive.

### SUMMARY

In one embodiment, a method of automatically updating a neighbor list associated with a serving base station is disclosed. The method comprises receiving, at the serving base station, a measurement report from a User Equipment (UE) associated with the serving base station, wherein the measurement report comprises at least one relative signal strength measurement between the UE and each of a plurality of neighboring base stations; comparing the at least one relative signal strength measurement between the UE and the each of the plurality of neighboring base stations with a current signal strength between the UE and the serving base station; identifying at least one of the plurality of neighboring base stations having a greater relative signal strength with respect to the UE than the serving base station a predefined number of times based on the comparison; and updating the neighbor list associated with the serving base station with the identified at least one neighboring base stations.

In another embodiment, a system for automatically updating a neighbor list is disclosed. The system comprises: a processor; and a memory disposed in communication with the processor and storing processor-executable instructions, the instructions comprising instructions to: receive a measurement report from a User Equipment (UE), wherein the measurement report comprises at least one relative signal strength measurement between the UE and each of a plurality of neighboring base stations; compare the at least one relative signal strength measurement between the UE and the each of the plurality of neighboring base stations with a current signal strength between the UE and the serving base station; identify at least one of the plurality of neighboring base stations having a greater relative signal strength with respect to the UE than the serving base station a predefined number of times based on the comparison; and update the neighbor list associated with the serving base station with the identified at least one neighboring base stations.

In another embodiment, a non-transitory computer-readable storage medium storing instructions which when executed by a processor enable the processor to automatically update a neighbor list is disclosed. The method comprising: receiving, at a serving base station, a measurement report from a User Equipment (UE) associated with the serving base station, wherein the measurement report comprises at least one relative signal strength measurement between the UE and each of a plurality of neighboring base stations; comparing the at least one relative signal strength measurement between the UE and the each of the plurality of neighboring base stations with a current signal strength between the UE and the serving base station; identifying at least one of the plurality of neighboring base stations having a greater relative signal strength with respect to the UE than the serving base station a predefined number of times based on the comparison; and updating the neighbor list associated with the serving base station with the identified at least one neighboring base stations.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates an exemplary broadband wireless network architecture in which various embodiments of the present disclosure may function.

FIG. 2 is a flow diagram illustrating a method of automatically updating a neighbor list in accordance with some embodiments of the present disclosure.

FIG. 3 is a block diagram illustrating a system for automatically updating a neighbor list in accordance with some embodiments of the present disclosure.

FIG. 4 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

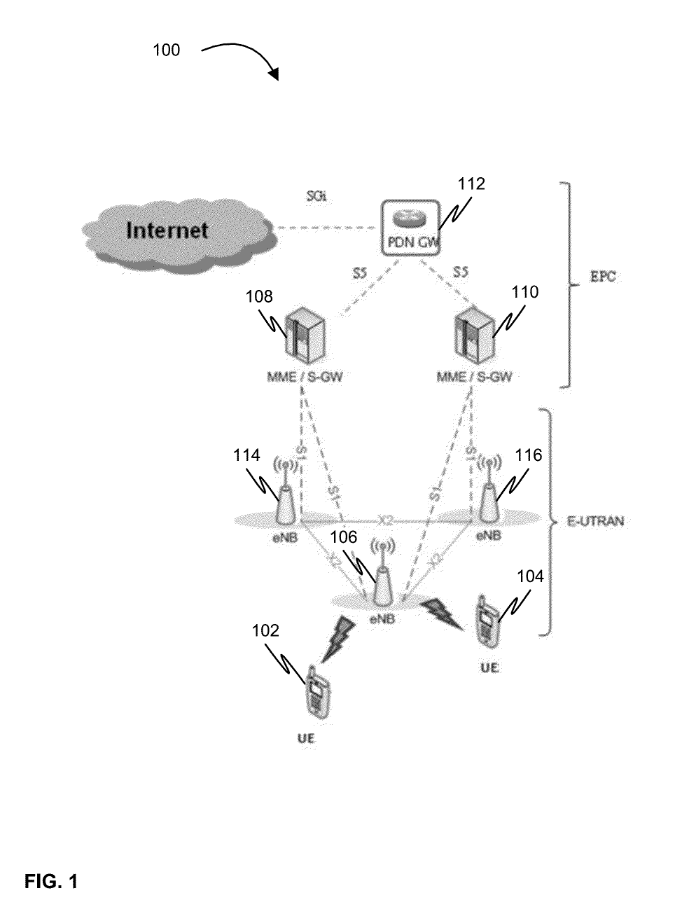

An exemplary high level network 100 depicting a broadband wireless network architecture is illustrated in FIG. 1. For purposes of illustration, the network 100 corresponds to an LTE network. However, the depicted LTE network is merely an exemplary network, and thus it will be understood that the teachings of the disclosure contemplate other broadband wireless networks such as WiMax, High Speed Packet Access (3GPP's HSPA), etc.

In FIG. 1, one or more user equipment (UE) such as UE 102 and UE 104 may communicate wirelessly with an eNB 106 that is an LTE base station. In this case, eNB 106 acts as the serving eNB for both UE 102 and UE 104. The functionalities of eNB 106 may include Radio Resource Management (RRM), header compression and encryption of user data stream, packet scheduling and transmission, physical layer processing, etc. An example of a UE may be a cell phone, PDA, tablet computer, etc. The eNB 106 may communicate with an evolved packet core (EPC) that may include a Mobility Management Entity (MME) associated with a serving gateway (S-GW). The MME and the S-GW are represented together in FIG. 1 as MME/S-GW 108 and MME/S-GW 110 for the sake of simplicity. However, it is to be noted that the MME and the S-GW in some embodiments may be separate and distinct entities. The MME manages and stores UE context and further generates temporary identities and allocates them to UEs. The SGW routes and forwards user data packets, while also acting as the mobility anchor for the user plane during inter-eNB handovers and as the anchor for mobility between LTE and other 3GPP technologies. Network 100 may further include a Packet Data Network Gateway (PDN GW) 112 that provides connectivity to UE 102 and UE 104 to external packet data networks by being the point of exit and entry of traffic for UE 102 and UE 104. A UE may have simultaneous connectivity with more than one PDN GW for accessing multiple PDNs. The PDN GW performs policy enforcement, packet filtering for each user, charging support, lawful Interception, etc.

In addition to the serving eNB 106, network 100 may further include neighboring eNBs such as an eNB 114 and an eNB 116. It is to be noted that, while only eNB 114 and eNB 116 are illustrated as neighbors in FIG. 1 for sake of simplicity, serving eNB 106 may have any number of neighbors. The serving eNB 106 may maintain a neighbor relation table (NRT) that provides information corresponding to neighboring eNBs. The NRT may be used by serving eNB 106 to determine which neighbor to handover a UE to. The NRT maintained by the serving eNB 106 may or may not include eNB 114 and eNB 116. For example, the NRT maintained by eNB 106 may include eNB 114 but not eNB 116. However, eNB 106 may discover neighbor eNB 116 using an Automatic Neighbor Relation (ANR) function. Here, the serving eNB 106 may receive measurement reports from all UEs current served by the eNB 106, that is, from UE 102 and UE 104. The measurement reports may include various signal strength measurements between the UE and a number of eNBs in the vicinity of the UE. In this case, UE 104 may detect a signal from eNB 116 and accordingly provide this information to serving eNB 106. The serving eNB 106 may check its own NRT to verify if eNB 116 has been added as a neighbor. On determining that eNB 116 is not on the NRT, serving eNB 106 may update the NRT to include the discovered neighbor eNB 116.

Additional illustrative embodiments are listed below. In one embodiment, a method of automatically updating a neighbor list associated with a serving base station or eNB is disclosed. The method involves initially receiving a measurement report from each UE associated with the serving eNB at step 202. In this case, the serving eNB may instruct all UEs connected to the serving eNB to perform a signal strength measurement and report their findings to the serving eNB. Hereinafter, the method shall be described by considering a single UE connected to the serving eNB. However, it is to be noted that the steps indicated for the single UE is to be repeated for each UE connected to the serving eNB. The measurement report transmitted by a UE connected to the serving eNB may include, but is not limited to, various relative signal strength measurements between the UE and each neighboring eNB from which the UE may receive a signal. The UE may, at any point of time, be within the range of numerous eNBs. Thus, a UE may report the signal strength between itself and a plurality of eNBs to the serving eNB. Further, the UE may also measure the signal strength between the UE and the serving eNB and include this measurement in the measurement report. The serving eNB may instruct each UE to perform these measurements periodically and report to the serving eNB. For example, each UE may transmit the measurement report to the serving eNB a number of times a minute.

On receiving the relative signal strength measurement between the UE and each of the neighboring eNBs, the serving eNB may compare the signal strength measurement between the UE and each of the neighboring eNBs against the current signal strength measurement between the UE and the serving eNB at step 204. In other words, the values of the signal strength measurements between the UE and a first neighboring eNB, the UE and a second neighboring eNB and so on may be compared with the signal strength measurement between the UE and the serving eNB. Based on the comparison, one or more neighboring eNBs having greater relative signal strength with respect to the UE than the serving eNB a predefined number of times may be identified at step 206. This step may be performed as a two stage process. Initially, all the neighboring eNBs which have even a single signal strength value greater than the current signal strength measurement between the UE and the serving eNB may be determined. Thereafter, the number of times the signal strength between the UE and an eNB is greater than the current signal strength between the UE and the serving eNB in a predefined time period may be determined. If the number of times the signal strength between the UE and the eNB is greater crosses a predefined number of times, then the eNB may be identified as a neighbor for handover. Subsequently, the neighbor list associated with the serving eNB may be updated with the identified neighbors at step 208. It is to be noted that updating the neighbor list may include adding identified neighbors not present in the default neighbor list and removing those neighbors from the default neighbor list that are not part of the identified neighbors.

In some embodiments, prior to updating the neighbor list, a handover failure ratio and/or a ping pong effect between the serving eNB and each of the identified neighbor eNBs may be determined. The handover failure ratio represents the ratio of the number of failed handovers to the number of handover attempts. The handover ratio and/or the ping pong effect between the serving eNB and an identified neighbor eNB may be used to further update the neighbor list. For example, if the handover failure ratio between the serving eNB and an identified neighbor is high, then that identified neighbor may be removed from consideration. Similarly, if the ping pong effect between the serving eNB and an identified neighbor is high, then that eNB may be removed from the NRT.

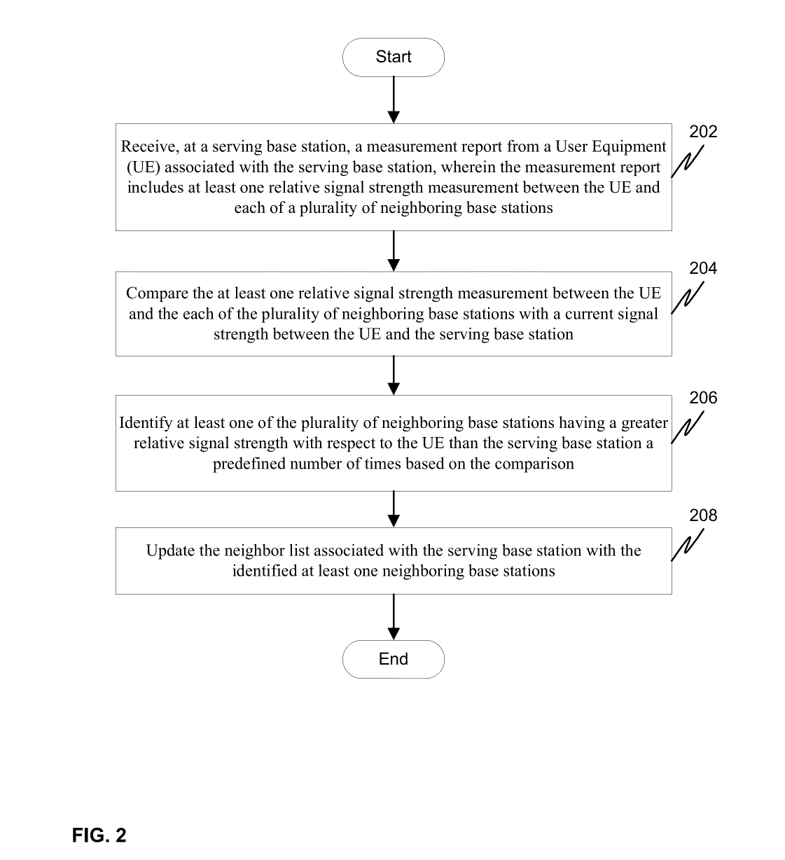

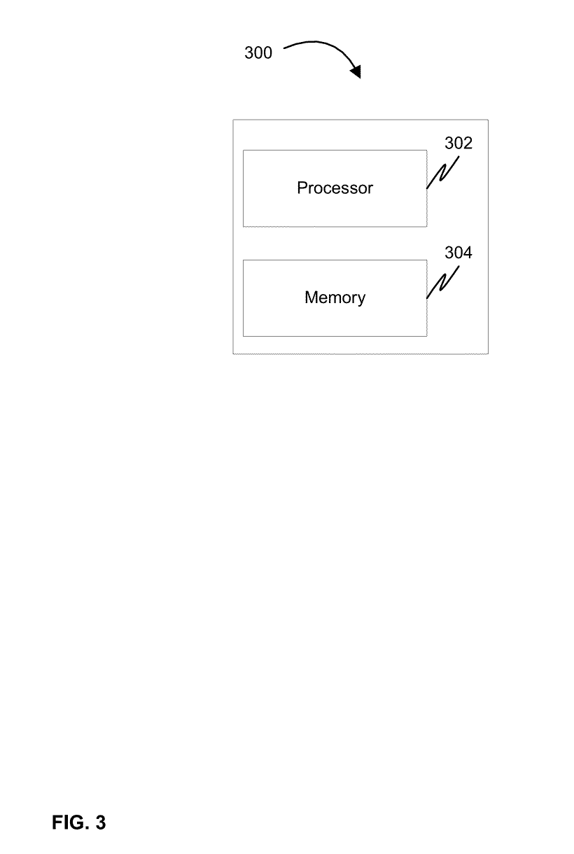

A system 300 associated with a serving eNB for automatically updating a neighbor list will now be explained in conjunction with FIG. 3. System 300 may include a processor 302 and a memory 304 disposed in communication with processor 302 and storing processor-executable instructions. The instructions may include instructions to receive measurement reports from User Equipment (UEs) associated with the serving eNB. A measurement report transmitted by a UE to the serving eNB may include one or more relative signal strength measurements between the UE and each of a plurality of neighboring base stations. Processor 302, in some embodiments, may instruct all UEs connected to the serving eNB to perform a signal strength measurement and report their findings to the serving eNB as explained in conjunction with FIG. 2.

On receiving the relative signal strength measurement between the UE and each of the neighboring eNBs, processor 302 may compare the signal strength measurement between the UE and each of the neighboring eNBs against the current signal strength measurement between the UE and the serving eNB. Based on the comparison, processor 302 may identify one or more neighboring eNBs having greater relative signal strength with respect to the UE than the serving eNB a predefined number of times. This step may be performed as a two stage process. Initially, all the neighboring eNBs which have even a single signal strength value greater than the current signal strength measurement between the UE and the serving eNB may be determined. Thereafter, the number of times the signal strength between the UE and an eNB is greater than the current signal strength between the UE and the serving eNB in a predefined time period may be determined. If the number of times the signal strength between the UE and the eNB is greater crosses a predefined number of times, then the eNB may be identified as a neighbor for handover. Subsequently, processor 302 may update the neighbor list associated with the serving eNB with the identified neighbors. As part of updating the neighbor list, processor 302 may add those identified neighbors that are not in the default neighbor list and also remove those neighbors in the default neighbor list that are not part of the identified neighbors.

Computer System

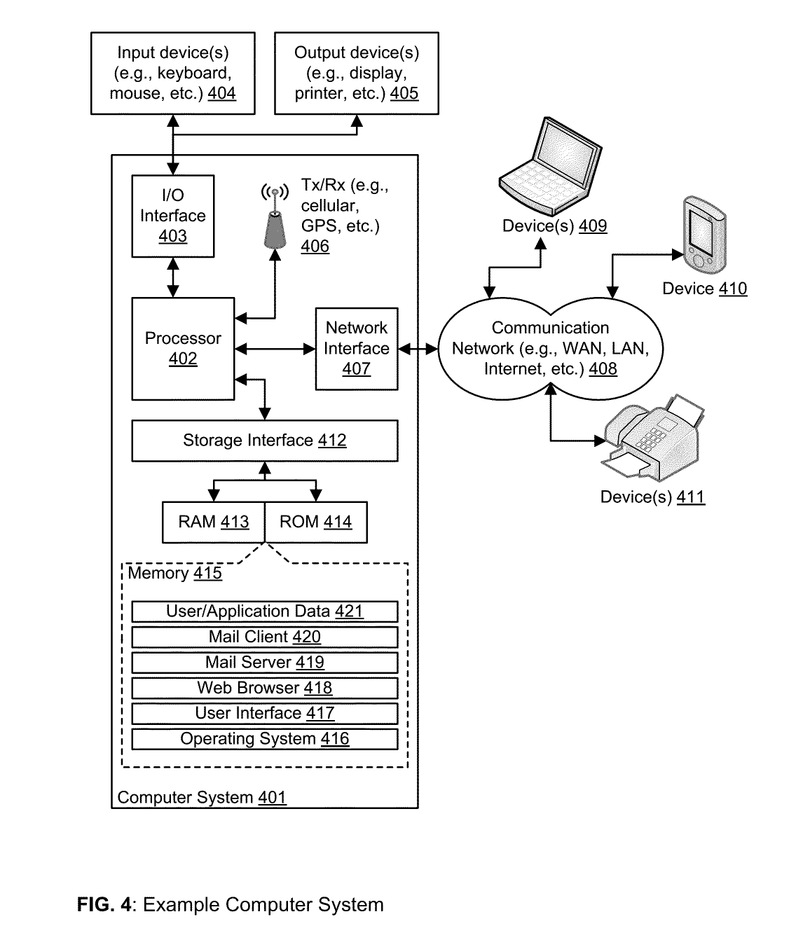

FIG. 4 is a block diagram of an exemplary computer system for implementing embodiments consistent with the present disclosure. Variations of computer system 401 may be used for implementing system 300 for automatically updating a neighbor list. Computer system 401 may comprise a central processing unit (“CPU” or “processor”) 402. Processor 402 may comprise at least one data processor for executing program components for executing user- or system-generated requests. A user may include a person, a person using a device such as such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 402 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 402 may be disposed in communication with one or more input/output (I/O) devices via I/O interface 403. The I/O interface 403 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 403, the computer system 401 may communicate with one or more I/O devices. For example, the input device 404 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 405 may be a printer, fax machine, video display (e.g., cathode ray tube (CRT), liquid crystal display (LCD), light-emitting diode (LED), plasma, or the like), audio speaker, etc. In some embodiments, a transceiver 406 may be disposed in connection with the processor 402. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 402 may be disposed in communication with a communication network 408 via a network interface 407. The network interface 407 may communicate with the communication network 408. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 408 may include, without limitation, a direct interconnection, local area network (LAN), wide area network (WAN), wireless network (e.g., using Wireless Application Protocol), the Internet, etc. Using the network interface 407 and the communication network 408, the computer system 401 may communicate with devices 410, 411, and 412. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 401 may itself embody one or more of these devices.

In some embodiments, the processor 402 may be disposed in communication with one or more memory devices (e.g., RAM 413, ROM 414, etc.) via a storage interface 412. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory devices may store a collection of program or database components, including, without limitation, an operating system 416, user interface application 417, web browser 418, mail server 419, mail client 420, user/application data 421 (e.g., any data variables or data records discussed in this disclosure), etc. The operating system 416 may facilitate resource management and operation of the computer system 401. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 417 may facilitate display, execution, interaction, manipulation, or operation of program components through textual or graphical facilities. For example, user interfaces may provide computer interaction interface elements on a display system operatively connected to the computer system 401, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 401 may implement a web browser 418 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 401 may implement a mail server 419 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 401 may implement a mail client 420 stored program component. The mail client may be a mail viewing application, such as Apple Mail, Microsoft Entourage, Microsoft Outlook, Mozilla Thunderbird, etc.

In some embodiments, computer system 401 may store user/application data 421, such as the data, variables, records, etc. as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

The specification has described a method of automatically updating a neighbor list associated with a serving eNB. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method of automatically updating a neighbor list associated with a serving base station, the method comprising:
receiving, at the serving base station, a measurement report from a User Equipment (UE) associated with the serving base station, wherein the measurement report comprises at least one relative signal strength measurement between the UE and each of a plurality of neighboring base stations;
comparing the at least one relative signal strength measurement between the UE and the each of the plurality of neighboring base stations with a current signal strength between the UE and the serving base station;
identifying at least one of the plurality of neighboring base stations having a greater relative signal strength with respect to the UE than the serving base station a predefined number of times based on the comparison; and
updating the neighbor list associated with the serving base station with the identified at least one neighboring base stations.

2. The method of claim 1 further comprising determining a handover failure ratio between the serving base station and each of the identified at least one neighboring base stations.

3. The method of claim 2 further comprising updating the neighbor list based on the handover failure ratio between the serving base station and the each of the identified at least one neighboring base stations.

4. The method of claim 1 further comprising determining a ping pong effect between the serving base station and each of the identified at least one neighboring base stations.

5. The method of claim 4 further comprising updating the neighbor list based on the ping pong effect between the serving base station and the each of the identified at least one neighboring base stations.

6. A base station computing device comprising:
a processor;
a memory, wherein the memory coupled to the processor which are configured to execute programmed instructions stored in the memory comprising:
receiving a measurement report from a User Equipment (UE), wherein the measurement report comprises at least one relative signal strength measurement between the UE and each of a plurality of neighboring base stations;
comparing the at least one relative signal strength measurement between the UE and the each of the plurality of neighboring base stations with a current signal strength between the UE and the serving base station;
identifying at least one of the plurality of neighboring base stations having a greater relative signal strength with respect to the UE than the serving base station a predefined number of times based on the comparison; and
updating the neighbor list associated with the serving base station with the identified at least one neighboring base stations.

7. The device of claim 6, wherein the processor is further configured to execute programmed instructions stored in the memory further comprising determining a handover failure ratio between the serving base station and each of the identified at least one neighboring base stations.

8. The device of claim 7, wherein the processor is further configured to execute programmed instructions stored in the memory further comprising updating the neighbor list based on the handover failure ratio between the serving base station and the each of the identified at least one neighboring base stations.

9. The device of claim 6, wherein the processor is further configured to execute programmed instructions stored in the memory further comprising determining a ping pong ratio between the serving base station and each of the identified at least one neighboring base stations.

10. The device of claim 9, wherein the processor is further configured to execute programmed instructions stored in the memory further comprising updating the neighbor list based on the ping pong ratio between the serving base station and the each of the identified at least one neighboring base stations.

11. A non-transitory computer-readable storage medium storing instructions which when executed by a processor enable the processor to automatically update a neighbor list, the method comprising:
receiving, at a serving base station, a measurement report from a User Equipment (UE) associated with the serving base station, wherein the measurement report comprises at least one relative signal strength measurement between the UE and each of a plurality of neighboring base stations;
comparing the at least one relative signal strength measurement between the UE and the each of the plurality of neighboring base stations with a current signal strength between the UE and the serving base station;
identifying at least one of the plurality of neighboring base stations having a greater relative signal strength with respect to the UE than the serving base station a predefined number of times based on the comparison; and
updating the neighbor list associated with the serving base station with the identified at least one neighboring base stations.

12. The non-transitory computer-readable storage medium of claim 11 further comprising determining a handover failure ratio between the serving base station and each of the identified at least one neighboring base stations.

13. The non-transitory computer-readable storage medium of claim 12 further comprising updating the neighbor list based on the handover failure ratio between the serving base station and the each of the identified at least one neighboring base stations.

14. The non-transitory computer-readable storage medium of claim 11 further comprising determining a ping pong ratio between the serving base station and each of the identified at least one neighboring base stations.

15. The non-transitory computer-readable storage medium of claim 14 further comprising updating the neighbor list based on the ping pong ratio between the serving base station and the each of the identified at least one neighboring base stations.
